(19) United States
(12) Patent Application Publication
(10) Pub. No.: US 2008/0303466 A1
(43) Pub. Date: Dec. 11, 2008

(54) FAN SYSTEM CONTAINING FAN CONTROL APPARATUS AND FAN CONTROL METHOD

(76) Inventor: JUN ETO, Tokyo (JP)

Correspondence Address: NEC CORPORATION OF AMERICA, 6535 N. STATE HWY 161, IRVING, TX, 75039, US

(21) Appl. No.: 12/055,672

(22) Filed: Mar. 26, 2008

(30) Foreign Application Priority Data
Mar. 29, 2007 (JP) 2007-089443

(51) Int. Cl. H02P 7/06

(52) U.S. Cl. 318/443

(57) ABSTRACT

A fan system includes a fan attached to a housing; and a DC motor configured to drive the fan. A fan control apparatus includes a control unit configured to control a rotation speed of the fan so as to periodically change around a specific rotation speed based on data corresponding to a specific rotation speed.

This patent application is based on Japanese Patent Application No. 2007-089443 filed on Mar. 29, 2007. The disclosure of Japanese Patent Application is incorporated herein by reference.

### TECHNICAL FIELD

The present invention relates to a fan system containing a fan control apparatus and a fan control method for controlling a fan.

### BACKGROUND ART

A computer device such as a server is generally provided with a cooling fan. Rotation of the fan causes vibration of the housing of computer device. Such vibration is considered to be a cause of fault in the computer device, and is not preferable. It is therefore desired to provide a technique for suppressing the housing vibration.

Meanwhile, the rotation of the fan occasionally generates vibration noise and wind noise. Such noises may be uncomfortable for those who are present around the fan. Another requirement for the fan is to reduce such uncomfortable feeling provided by the noises of

In conjunction to the above description, first to third related arts (Japanese Patent Application Publications (JP-P2005-76540A, JP-A-Heisei 9-212044, and JP-A-Heisei 5-221227) disclose techniques for reducing the uncomfortable feeling. That is, the first related art describes how to control an air capacity of a heat radiation fan by using 1/f fluctuation characteristic. The second related art also discloses an image forming apparatus having a heat radiation fan, in which an input voltage to the fan is controlled based on periodic components of 1/f fluctuation. The third related art further discloses an air conditioner provided with a reference blower determining section adapted to determine a voltage to be outputted to a blower motor, a lower blower determining section adapted to determine a blower voltage which is lower than a reference blower voltage determined based on the reference blower determination section, and a fluctuation width applying section adapted to apply a fluctuation width to the lower blower voltage.

However, none of the above related arts describes how to suppress housing vibration.

### SUMMARY

Therefore, an object of the present invention is to provide a fan system containing a fan control apparatus and fan control method in which housing vibration can be suppressed.

In an exemplary embodiment of the present invention, a fan system includes a fan attached to a housing; a DC motor configured to drive the fan; and a fan control apparatus including a control unit configured to control a rotation speed of the fan so as to periodically change around a specific rotation speed based on data corresponding to a specific rotation speed.

In another exemplary embodiment of the present invention, a fan control method includes driving a fan attached to a housing by a DC motor; and controlling a rotation speed of the fan so as to periodically change around a specific rotation speed based on data corresponding to a specific rotation speed.

### BRIEF DESCRIPTION OF DRAWINGS

The above and other objects, advantages and features of the present invention will be more apparent from the following description of certain exemplary embodiments taken in conjunction with the accompanying drawings, in which:

FIG. 1 is a block diagram showing a schematic configuration of a fan system including a fan control apparatus according to an exemplary embodiment of the present invention;

FIG. 2A is a diagram showing that voltage oscillates in a sinusoidal waveform having an amplitude ·V and a period T;

FIG. 2B is a graph showing temporal change of current i when the voltage applied to a DC motor is constant;

FIG. 2C is a diagram showing the voltage applied to the DC motor;

FIG. 3A is a graph showing a simulation result of a first example;

FIG. 3B is a graph showing a simulation result of a second example; and

FIG. 3C is a graph showing a simulation result of a third example.

### EXEMPLARY EMBODIMENTS

Hereinafter, a fan system using a fan control apparatus and a fan according to exemplary embodiments of the present invention will be described with reference to the attached drawings.

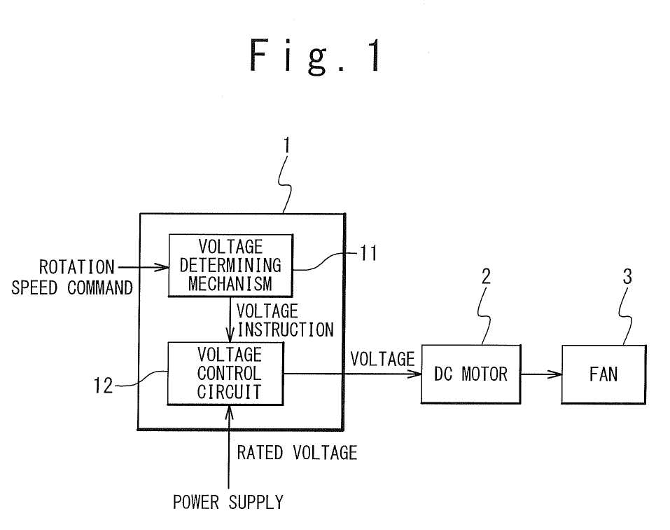

FIG. 1 is a block diagram showing a schematic configuration of a fan system according to an exemplary embodiment of the present invention. The fan system includes a fan control apparatus 1, a DC motor, and a fan 3 controlled by the fan control apparatus 1. As shown in FIG. 1, the fan 3 is connected to a DC motor 2 and rotated by driving the DC motor 2. The fan control apparatus 1 according to the first exemplary embodiment applies a voltage to the DC motor 2 in the form of pulses and controls a magnitude of a voltage to be applied with respect to time in order to control a rotational speed of the fan 3.

The fan 3 may be integrally formed with a housing of a server (not shown), and may be formed discretely. Rotation of the fan 3 generates vibration which is propagated through the housing of the server and causes vibration of the housing. If the fan 3 is made to rotate by the DC motor 2 as shown in the first exemplary embodiment, the rotational speed of the fan 3 is proportional to a voltage applied to the DC motor 2.

The fan control apparatus 1 is provided with a voltage determining mechanism 11 and a voltage control circuit (or control unit) 12. The voltage determining mechanism 11 realizes a function to determine a voltage and a pulse width applied to the DC motor 2 on the basis of an inputted rotation speed command in order to notify them to the voltage control circuit 11. For example, a corresponding relationship between a voltage and a rotation speed of the fan 3 has been obtained in advance and a voltage can be determined by referring to this corresponding relationship. The voltage determining mechanism 11 may be also composed of a CPU and a program installed in a device such as a ROM, for example. The voltage control circuit 12 is connected to a power source, in which a rated voltage supplied from the power source is transformed into a voltage notified by the voltage determining mechanism 11 and is supplied to the DC motor 2. At this time, a voltage is applied to the DC motor 2 pulsewise on the basis of a pulse width notified by the voltage determining mechanism 11.

Next, an operation of the fan system including the fan control apparatus 1 according to the first exemplary embodiment will be described in detail below.

First, a rotation speed command is inputted to the fan control apparatus 1. The rotation speed command is a data indicative of a specific rotation speed. The specific rotation speed indicates a rotation speed required for the fan 3 and is inputted to the fan control apparatus 1 on the basis of a data inputted by a user from an input unit such as a keyboard (not shown) and a temperature measuring results in a hosing detected by a temperature sensor (not shown) or other data. Although generating such a specific rotation speed is omitted from the drawings, it can be realized by a computer program installed in a server, for example.

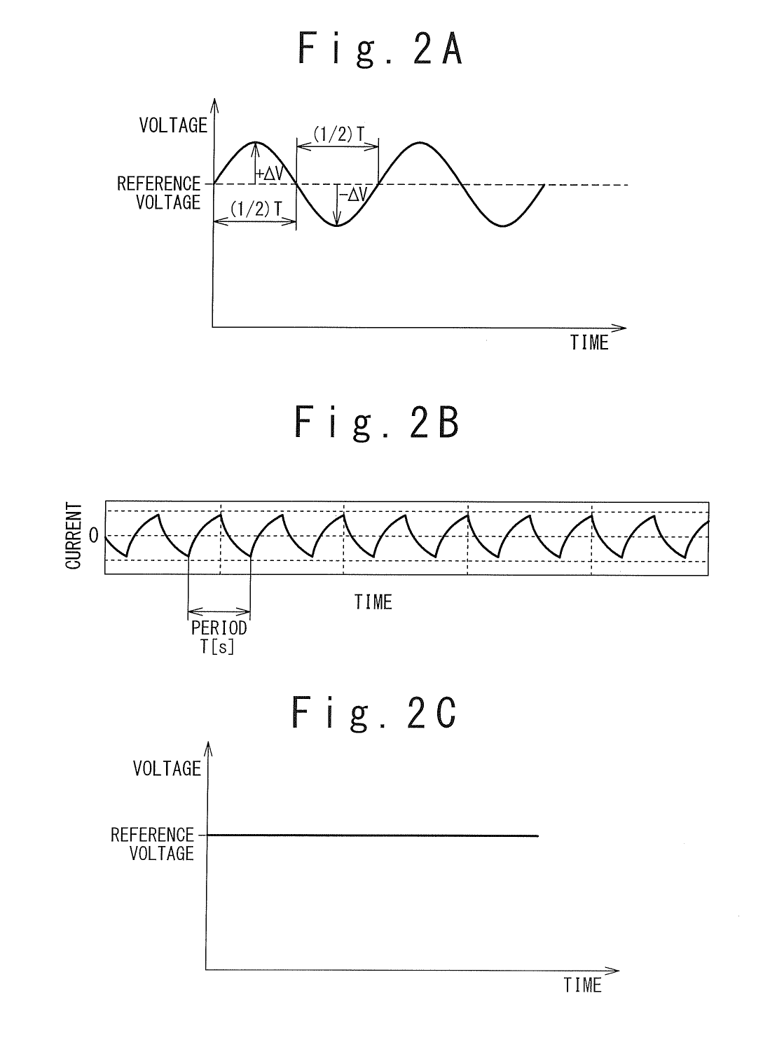

Subsequently, the voltage determining mechanism 11 performs an operation in response to the rotation speed command to determine a voltage and pulse width of pulses applied to the DC motor 2. More specifically, a voltage to achieve the specific rotation speed indicated by the rotation speed command is calculated. The voltage may be referred to as a reference voltage V. The voltage determining mechanism 11 notifies the reference voltage V and the pulse width to the voltage control circuit 12. The voltage control circuit 12 transforms a rated voltage supplied from a power supply on the basis of the reference voltage V and the pulse width to supply to the DC motor 2. Therefore, the DC motor 2 is driven to rotate the fan 3. At this time, the voltage control circuit 12 applies a voltage in each of the pulses so that the voltage oscillates in a period T in a range of ±·V with respect to the reference voltage V, as shown in FIG. 2A. It should be noted that FIG. 2A shows an example in which the voltage oscillates in a sinusoidal waveform having the amplitude of ·V and the period T. The rotation speed of the fan 3 is substantially consistent with the voltage applied to the DC motor 2. Accordingly, the rotation speed of the fan 3 shows a behavior that the rotation speed oscillates in the period T on the both sides with respect to the specific rotation speed.

By the way, a vibration source of the fan 3 is considered to be a torque of the DC motor 2. The torque is proportional to a current i flowing through a wire of the DC motor 2 according to Fleming's left hand rule (i.e., F=iBL, where F is torque, i is the current, B is a magnetic flux and L is a length of the wire). A direction of the current flowing through the wire of the DC motor 2 temporally changes with rotation of a coil of the DC motor 2. FIG. 2B is a graph showing a temporal change of the current i when the voltage applied to the DC motor 2 is constant as shown in FIG. 2C. As shown in this graph, the period of the current is constant, i.e., Ti when the applied voltage is constant. In contrast, the period of the current i is not constant when the voltage applied to the DC motor 2 is temporally changed. Since the current i is proportional to the torque, the torque does not have a constant period. That is, the torque is dispersed into a plurality of frequency components. A peak value of the torque is also reduced through the dispersion into the plurality of the frequencies. As a result, a vibration peak value of the fan 3 is also reduced. Thus, deterioration of devices such as a hard disc drive provided in the server can be suppressed. It should be noted that the period Ti of the current i is provided in a more irregular form when the change of the voltage applied to the DC motor 2 has a sinusoidal waveform. Accordingly, the voltage applied to the DC motor 2 is made to have the sinusoidal waveform so that vibration of the fan 3 is dispersed into frequency components in a wider frequency range. Thus, it is possible to suppress deterioration of devices more efficiently.

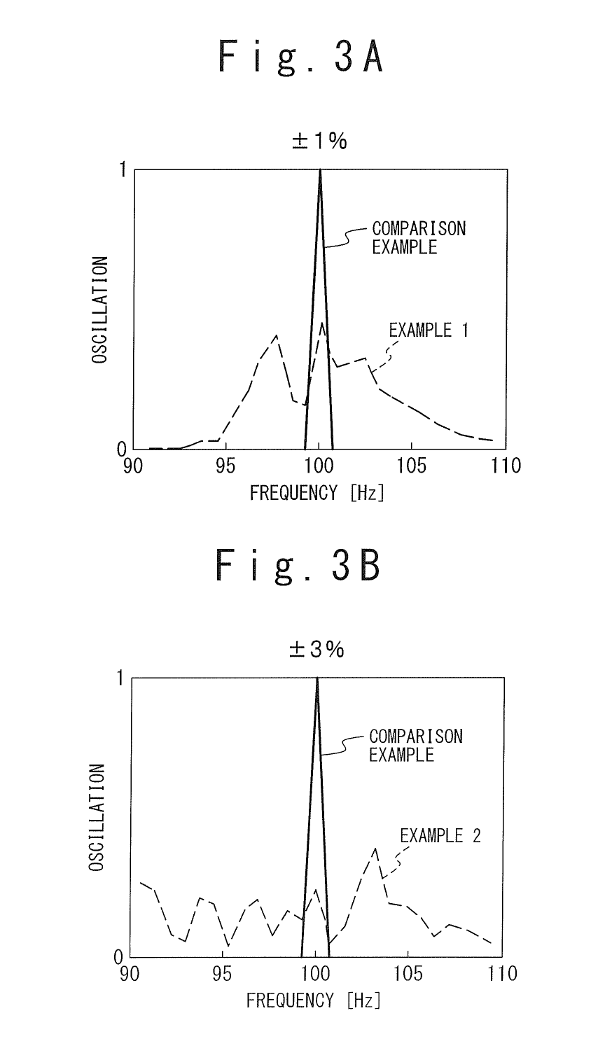

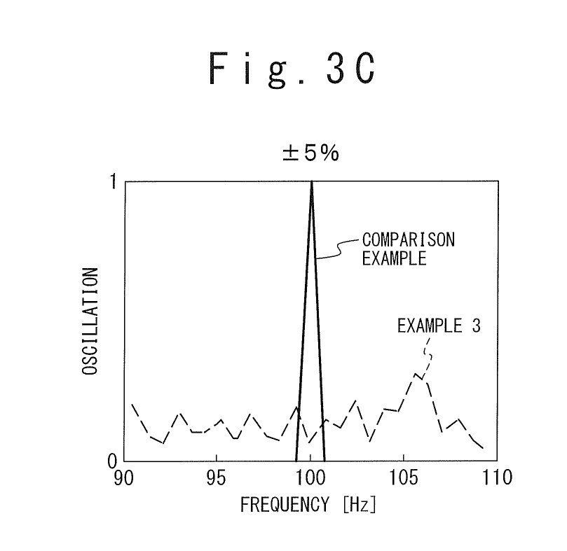

FIGS. 3A to 3C are graphs showing simulation results of a relationship of a vibration amount of the housing when the fan 3 is driven, and a vibration frequency of the housing. In each of FIGS. 3A to 3C, a solid line indicates a result of a comparison example while a broken line indicates each of results of first to third examples. FIG. 3A shows the result of the first example, FIG. 3B shows the result of the second example, and FIG. 3C shows the result of the third example. The result of the comparison example shows a result when a constant voltage is applied to the DC motor 2 such that the rotation speed of the fan is 6000 rpm (100 Hz) and constant. The results of the first to third examples are results when the voltages applied to the DC motor 2 have a sinusoidal waveform. The result of the first example shows a result in case of the specific rotation speed of 6000 rpm (100 Hz), the period T of 1.28 seconds (128 rotations), and the amplitude ·V of 1% of the reference voltage V. The result of the second example shows a result in case of the amplitude ·V of 3% of the reference voltage V, and the result of the third example shows a result in case of the amplitude ·V of 5% of the reference voltage V. In the second and third examples, parameters other than the amplitude ·V remain same as those of the first example. In the simulation, a temporal change of the current flowing through the wire of the DC motor 2 as shown in FIG. 2B is calculated on the basis of temporal change of the voltage applied to the DC motor 2. A temporal change of the current is Fourier-transformed to calculate a torque in each frequency component. As stated above, the torque can be understood as a vibration amount of the housing. Accordingly, the vibrations of the housing have been determined by normalizing the torques in the first to third examples to a value between 0 and 1 based on a peak value of the torque in the comparison example as “1”.

As shown in FIGS. 3A to 3C, remarkable vibration is confirmed in the comparison example at 100 Hz which is consistent with the rotation speed of the fan. In contrast, although the vibration in frequency components of a wide range is observed in the first to third examples, the vibration peak value is suppressed, in comparison with the comparison example. That is, it was confirmed that the vibration amount of the housing is dispersed into wider frequency components and the peak value of the vibration amount is made lower by changing the voltage applied to the DC motor 2.

Next, the result when the amplitude ·V is changed will be described. When the amplitude ·V from 1% (first example) to 3% (second example) is increased, the vibration is dispersed into a wider frequency range to reduce the peak value. That is, the vibration energy is distributed in a wide frequency range. However, no significant difference is observed in the vibration dispersion and the peak value reduction even if the amplitude ·V is increased from 3% to 5% (third example). Original cooling effect of the fan is considered to deteriorate if the amplitude ·V is too large. Accordingly, from a viewpoint of the cooing effect and vibration dispersion effect, the amplitude ·V is preferably set to 0 to 3%.

Although the exemplary embodiments shows the example in which the rotation speed command is inputted and the voltage determining mechanism 11 converts the rotation speed command into a voltage command, it is not necessarily required to input a data indicating the specific rotation speed as long as a data corresponding to the specific rotation speed is inputted. For example, a voltage data corresponding to the specific rotation speed may be directly generated and inputted to the fan control apparatus 1. In this case, the voltage determining mechanism 11 need not to generate a voltage command on the basis of the rotation speed command, and it is sufficient that only a pulse width is determined. If the pulse width is externally generated and inputted to the fan control apparatus 1, the voltage determining mechanism 11 itself is not required.

While the present invention has been particularly shown and described with reference to the exemplary embodiments thereof, the present invention is not limited to these exemplary embodiments. It will be understood by those of ordinary skill in the art that various changes in form and details may be made therein without departing from the spirit and scope of the present invention as defined by the claims.

What is claimed is:

1. A fan system comprising:
a fan attached to a housing;
a DC motor configured to drive said fan; and
a fan control apparatus comprising a control unit configured to control a rotation speed of said fan so as to periodically change around a specific rotation speed based on data corresponding to a specific rotation speed.

2. The fan system according to claim 1, wherein said control unit controls the rotation speed of said fan such that vibration energy of said housing is dispersed in a frequency range.

3. The fan system according to claim 1, wherein said control unit controls the rotation speed of said fan by controlling a voltage to be applied to said DC motor.

4. The fan system according to claim 1, wherein said control unit controls the rotation speed of said fan to periodically change in a sinusoidal waveform, taking the specific rotation speed as amplitude center.

5. The fan system according to claim 1, wherein said control unit controls the rotation speed of said fan in a range of ±3% with respect to the specific rotation speed.

6. The fan system according to claim 1, wherein said housing is for a server.

7. A fan control method comprising:
driving a fan attached to a housing by a DC motor; and
controlling a rotation speed of said fan so as to periodically change around a specific rotation speed based on data corresponding to a specific rotation speed.

8. The fan control method according to claim 7, wherein said controlling comprises:
controlling the rotation speed of said fan such that vibration energy of said housing is dispersed in a frequency range.

9. The fan control method according to claim 7, wherein said controlling comprises:
controlling the rotation speed of said fan by controlling a voltage to be applied to said DC motor.

10. The fan control method according to claim 7, wherein said controlling comprises:
controlling the rotation speed of said fan to periodically change in a sinusoidal waveform, taking the specific rotation speed as amplitude center.

11. The fan control method according to claim 7, wherein said controlling comprises:
controlling the rotation speed of said fan in a range of ±3% with respect to the specific rotation speed.

12. A fan control apparatus comprising:
a control unit configured to control a rotation speed of a fan so as to periodically change around a specific rotation speed based on data corresponding to a specific rotation speed.

13. The fan control apparatus according to claim 12, wherein said control unit controls the rotation speed of said fan such that vibration energy of a housing to which said fan is attached, is dispersed in a frequency range.

14. The fan control apparatus according to claim 12, wherein said control unit controls the rotation speed of said fan by controlling a voltage to be applied to a DC motor which drives said fan.

15. The fan control apparatus according to claim 12, wherein said control unit controls the rotation speed of said fan to periodically change in a sinusoidal waveform, taking the specific rotation speed as amplitude center.

16. The fan control apparatus according to claim 12, wherein said control unit controls the rotation speed of said fan in a range of ±3% with respect to the specific rotation speed.

17. The fan control apparatus according to claim 12, wherein said housing is for a server.
